(19) United States
(12) Patent Application Publication
(10) Pub. No.: US 2009/0222921 A1
(43) Pub. Date: Sep. 3, 2009

(54) Technique and Architecture for Cognitive Coordination of Resources in a Distributed Network

(75) Inventors: Supratik Mukhopadhyay, Providene, UT (US); Krishna Shenai, Naperville, IL (US); Rabindra K. Roy, Milpitas, CA (US); Nathan Jack, Urbana, IL (US)

Correspondence Address: UTAH STATE UNIVERSITY, TECHNOLOGY COMMERCIALIZATION OFFICE, 570 RESEARCH PARK WAY, SUITE 101, NORTH LOGAN, UT, 84341, US

(73) Assignee: Utah State University, North Logan, UT (US)

(21) Appl. No.: 12/040,553

(22) Filed: Feb. 29, 2008

(51) Int. Cl. G08B 23/00; G06F 9/45; G06F 15/173; G06N 5/02

(52) U.S. Cl. 726/23; 717/104; 709/224; 706/47

(57) ABSTRACT

A system and method are disclosed for utilizing resources of a network. A constructive proof that a subset of resources is sufficient to satisfy the objective of a system can be generated. The constructive proof can comprise instructions for using the subset of resources. A set of computer-executable instructions can be created from the constructive proof and executed on a host device. The computer-executable instructions can control a data output device according to the instructions of the constructive proof.

### TECHNICAL FIELD

This disclosure relates generally to networks, and relates more specifically to systems and methods for using network resources.

### BACKGROUND OF THE INVENTION

Networks can suffer from a variety of problems or limitations. In particular, collaboration and coordination among various components of a given network can pose a variety of challenges, particularly for heterogeneous networks. Reliability and security are often complicated by such matters as timing requirements, security requirements and/or fault tolerances of the services and/or devices. These issues are addressed herein with the description of a system that contains one or more resources, including any suitable input or source of information, and an output that can include any suitable receiver of information or data output device.

### SUMMARY OF THE INVENTION

The system further includes a coordination layer, system, or control shell which allows for the satisfaction of policies, objectives and/or quality of service goals, each of which may be user-defined. The coordination layer permits reliable communication between resources and output devices in a heterogeneous network. The coordination layer can promote the conformance of services and information exchanged over the network to the goals of a user and/or can promote observance of the performance desires that a user wishes for a system to exhibit. For example, the coordination layer provides formal guarantees that user-defined system objectives and quality of service requirements are met. The coordination layer can respond to diverse local policies governing computation and communication in individual computing elements and local networks, as well as changes to a network. The coordination layer can dynamically adapt to changes in the network, such as failures or security breaches of individual services or devices, and can automatically provide for the successful achievement of the goals or objectives of the network.

### BRIEF DESCRIPTION OF THE DRAWINGS

FIG. 1 is a block diagram of an embodiment of a shell for using network resources in connection with an output device.

FIG. 2 is a block diagram of another embodiment of a shell for using network resources in connection with an output device.

FIG. 3SA is a block diagram of another embodiment of a shell for using network resources in connection with output devices, and depicts components of the shell.

FIG. 3B is a block diagram of another embodiment of a shell for using network resources in connection with output devices.

FIG. 4 is a schematic diagram of an embodiment of a coast guard system configured for coordinated use of network resources.

FIG. 5 is a block diagram of an embodiment of a multi-level system that includes a plurality of sensors.

FIG. 6 is a block diagram illustrating at least a portion of an embodiment of a sensor that includes a wireless transmitter.

FIG. 7 is a block diagram illustrating an embodiment of a wireless receiver.

FIG. 8 is a block diagram of an embodiment of an access point that includes a wireless receiver, a smart card, and a transceiver.

### DETAILED DESCRIPTION OF PREFERRED EMBODIMENTS

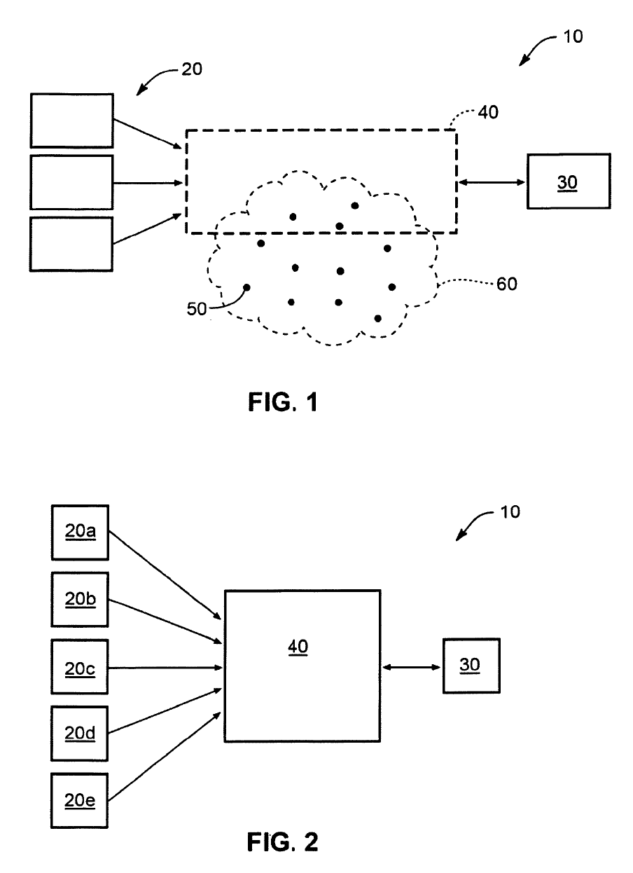

The embodiments of the disclosure wilt be best understood by reference to the drawings, wherein like parts are designated by like numerals throughout. It will be readily understood that the components, as generally described and illustrated in the Figures herein, could be arranged and designed in a wide variety of different configurations. Thus, the following more detailed description of the embodiments of the system and method of the disclosure, as represented in FIGS. 1-8 is not intended to limit the scope of the disclosure, as claimed, but is merely representative of possible embodiments of the disclosure.

Much of the infrastructure that can be used with embodiments disclosed herein is already available, such as: general purpose computers; computer programming tools and techniques; computer networks and networking technologies; wireless communication; and digital storage media.

Suitable networks for configuration and/or use as described herein include one or more local area networks, wide area networks, metropolitan area networks, and/or “Internet” or IP networks such as the World Wide Web, a private Internet, a secure Internet, a value-added network, a virtual private network, an extranet, an intranet, or even standalone machines which communicate with other machines by physical transport of media. In particular, a suitable network may be formed from parts or entireties of two or more other networks, including networks using disparate hardware and network communication technologies. A network may incorporate land lines, wireless communication, and combinations thereof.

The network may include communications or networking software such as software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. The network may encompass smaller networks and/or be connectable to other networks through a gateway or similar mechanism.

Suitable networks can include a server and several clients; other suitable networks may contain other combinations of servers, clients, and/or peer-to-peer nodes, and a given computer may function both as a client and as a server. Each network can include one or more computers, such as the server and/or clients. A computer may be a workstation, laptop computer, disconnectable mobile computer, server, mainframe, cluster, so-called “network computer” or “thin client”, mobile telephone, personal digital assistant or other hand-held computing device, “smart” consumer electronics device or appliance, or a combination thereof.

Suitable networks can also include one or more physical sensors and/or physical actuators that either communicate with nodes of a network or are themselves nodes of the network. For example, a network can include a wireless sensor network of physical sensors. Physical sensors can include one or more motion sensors, heat sensors, chemical sensors, moisture sensors, photo detectors, or any other suitable data-gathering device configured to sense a physical quantity. The physical sensors can deliver information regarding a physical quantity to the network in any suitable manner, such as by electrical or light signals. Physical actuators can be configured to receive instructions from the network and to produce a physical action as a result. For example, the physical actuators can include one or more motors, triggers, solenoids, or other suitable devices.

Each computer of a network may include a processor such as a microprocessor, microcontroller, logic circuitry or the like. The processor may include a special purpose processing device such as an ASIC, PAL, PLA, PLD, Field Programmable Gate Array, or other customized or programmable device. The computer may also include a memory such as non-volatile memory, static RAM, dynamic RAM, ROM, CD-ROM, disk, tape, magnetic, optical, flash memory, or other computer storage medium. The computer may also include various input devices and/or output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

Aspects of certain of the embodiments described are illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

The software modules tangibly embody a program, functions, and/or instructions that are executable by computer(s) to perform tasks as described herein. Suitable software, as applicable, may be readily provided by those of skill in the pertinent art(s) using the teachings presented herein and programming languages and tools such as, for example, XML, Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Networks can suffer from a variety of problems or limitations. In particular, collaboration and coordination among various components of a given network can pose a variety of challenges, particularly for heterogeneous networks. For example, some networks include disparate sensing, computing, and/or actuating devices that interface via wired and/or wireless connections and/or that run on different platforms (e.g., on different operating systems). Such networks are widely used in healthcare, military, automobile, building security, and space industries, among others, which often depend upon reliable delivery of service from elements of the network and upon secure and trustworthy exchange of information among network elements. Reliability and security are often complicated by such matters as timing requirements, security requirements, and/or fault tolerances of the services and/or devices.

A variety of complications can arise in such networks. For example, clients or services can migrate from one physical location to another, which can complicate failure semantics. Clients or services may operate in limited resource environments (e.g., on PDA's) having bandwidth limitations and/or shortage of space or other resources. In some instances, clients or services may communicate different types of data (e.g., voice information, multimedia information, etc.) through communication channels that are unreliable, are susceptible of eavesdropping, and/or conform to differing standards (e.g., 802.11, Zigbee, etc.). The exchange of information in some networks can involve passing messages that include semi-structured data, the integrity of which may be compromised due to the presence of possible faults or breaches in the network. Indeed, the diverse platforms, computing elements, and/or sensing elements of some networks may provide heterogeneous, semi-structured data having untraced or uncertified pedigrees, and individual nodes or even entire subnetworks of a given network may fail or be compromised.

Various embodiments described herein address some or all of the foregoing issues, as well as others that may or may not be discussed below. For example, in some embodiments, a coordination layer is provided that permits reliable communication between resources and output devices in a heterogeneous network. The coordination layer can promote the conformance of services and information exchanged over the network to the goals of a user and/or can promote observance of the performance desires that a user wishes for a system to exhibit. For example, in some embodiments, the coordination layer provides formal guarantees that user-defines system objectives and quality of service requirements are met. In some embodiments, the coordination layer can respond to diverse local policies governing computation and communication in individual computing elements and local networks, as well as changes to a network (such as failures or compromises of individual nodes or subnetworks). In some embodiments, the coordination layer can dynamically adapt to changes in the network, such as failures or security breaches of individual services or devices, and can automatically provide for the successful achievement of the goals or objectives of the network (which in some instances, are user-defined). Other features and advantages of various embodiments are described below and will be apparent to those of skill in the art from the disclosure herein.

With reference to FIG. 1, in certain embodiments, a system 10 includes one or more resources 20 and an output 30. The resources 20 can include any suitable input or source of information. For example, the resources 20 can include one or more services (whether stateless and/or stateful) or devices, such as online applications, software applications, computing elements, control stations, personal computers, personal electronic devices (such as personal digital assistants, smart phones, etc.), and/or input devices, such as, for example, keyboards, mouse devices, and/or physical sensors or other hardware devices configured to sense and, in some instances, to communicate one or more measurements and/or aspects of a physical property or physical action. The output 30 can include any suitable receiver of information or data output device. For example, the output 30 can include a client, an online application, software application, computing element, control station, personal computer, personal electronic device, display, and/or physical actuator. In some embodiments, the system 10 includes multiple outputs 30.

The system 10 further includes a layer, system; or control shell 40. In certain embodiments, the shell 40 allows for the satisfaction of policies, objectives and/or quality of service goals, each of which may be user-defined, of the system 10. For example, in some embodiments, the shell 40 is capable of automatically determining the availability of one or more of the resources 20, selecting among the resources 20 to obtain the most reliable, cogent, or timely information for delivery to the output 30, and delivering the information thus obtained to the output 30 in a suitable format. In some embodiments, principles of artificial intelligence and programming languages are used to construct the shell 40, as further described below.

In some embodiments, the shell 40 is distributed among one or more nodes 50 that are arranged in a network 60. For example, in the illustrated embodiment, the shell 40 is distributed among three nodes 50. Each node 50 can comprise a storage device capable of storing information in a tangible medium. In some embodiments, one or more nodes 50 comprise one or more resources 20 and/or one or more outputs 30.

As a non-limiting example, in the embodiment depicted in FIG. 2, the system 10 can comprise a sprinkling system. The resources 20a-e of the sprinkling system can provide various forms of information regarding the landscaped property at which the sprinkling system is installed. For example, one resource 20a can comprise a first clock, another resource 20b can comprise a second clock, another resource 20c can comprise a moisture sensor in the soil of the property, another resource 20d can comprise a thermometer measuring the air temperature at the property, and another resource 20e can comprise an online weather forecast application. The output 30 can comprise an actuator configured to activate or deactivate the sprinkling system. Each of the services 20a-e and the output 30 is in communication with the shell 40.

The shell 40 can include rules for instructing the output 30 to activate or deactivate the sprinkling system based on information received from one or more of the resources 20a-e. For example, the shell 40 can include a rule set for determining whether to activate the sprinkling system, such as the following:.

1. Activate at 6:00 a.m. unless:
a. moisture content of soil is above a threshold value;
b. air temperature is below a threshold value; or
c. heavy precipitation is predicted for the day;

2. Activate if moisture content of soil is below a threshold value;

3. Activate if air temperature has been above a threshold value for 12 hours; or

4. Activate if sprinkling system has been off for 12 hours and predicted peak temperature for the day is above threshold value and no precipitation is predicted for the day.

The shell 40 can gather information from the resources 20a-e and, based on the rule set, provide appropriate instructions to the output 30. Additionally, the shell 40 can monitor the availability and/or operational status of each of the resources 20a-d and adapt the decision-making process in response to any changes that may occur to the system 10.

For example, the shell 40 can be configured to apply only the first rule of the rule set if one or more of the clocks (resources 20a, 2b) are available. If the shell 40 senses that the clock (resource 20a) is unavailable or inaccurate, such as may result from a brief power outage or other resetting event, the shell 40 can instead use the clock 20b. Additionally, the shell 40 can be configured to disregard the first rule and apply one or more of the second, third, and fourth rules if both of the clocks 20a, 20b are unavailable or inaccurate.

In some embodiments, the shell 40 employs decentralized, context-aware programming models (further described below) that model workflows for processing of information regarding the current configuration (e.g., the state, status, or availability of one or more of the resources 20) of the system 10 and for discovering and composing services in order to adapt to future configurations of the system 10. The workflows can comprise business process models that consist of partially ordered sequences of cooperating and coordinated tasks executed to meet the objectives of the system 10 and/or the output 30.

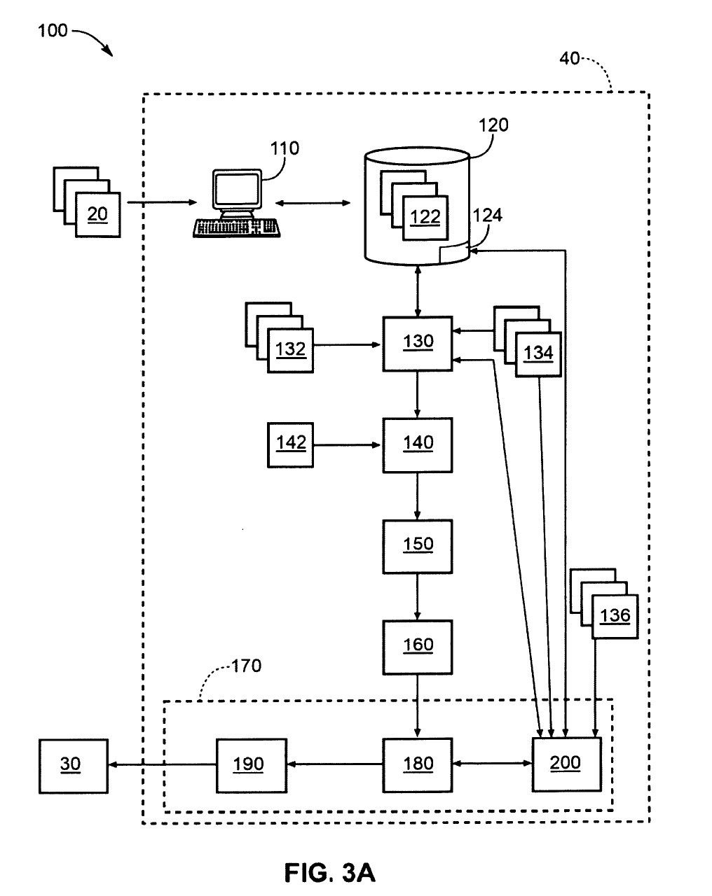

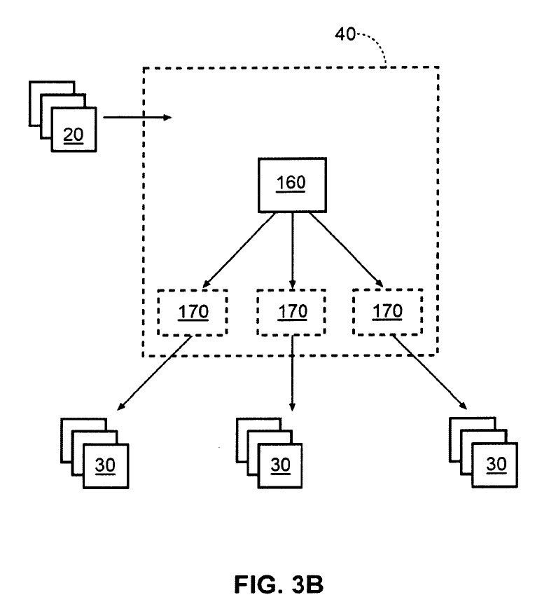

With reference to FIG. 3A, in certain embodiments, a system 100 such as the system 10 comprises one or more resources 20 and an output 30 in communication with a shell 40. In other embodiments, the system 100 can include multiple outputs 30. Components of the shell 40 can be distributed among one or more nodes of a network 60 (see FIG. 1) in any suitable manner. The shell 40 can include one or more gateways or control points 110 configured to communicate with the resources 20. Any suitable communication interface can be employed between the resources 20 and the control point 110, such as wired or wireless connections The control point 110 can include any suitable device or system, and in some embodiments, comprises a computer.

In some embodiments, the control point 110 is in communication with a directory 120, and can be used to provide information to the directory 120. For example, information regarding the resources 20 can be provided to the directory 120 via the control point 110. The information for a particular resource 20 can include instructions for accessing the resource 20, a description of data available from the resource 20 (e.g., data that can be input to the shell 40 from the resource 20), instructions for providing data to the resource 20 (e.g., data that can be output from the shell 40 to the resource 20), instructions for processing data received from the resource 20, temporal behaviors of the resource 20 (e.g.,real-time constraints, or actions performed over time, such as, for example, sending a message, operating a hardware device, etc.), and/or pre-call and post-call conditions of the resource 20. In some embodiments, the directory 120 thus can provide for communication with one or more resources 20 that comprise stateless and/or stateful services. In some embodiments, the directory 120 is an example of means for storing information regarding resources that are available to the system 100.

In some arrangements, the information can be entered into the directory 120 via the control point 110, such as Via a computer keyboard. The control point 110 can include a graphical user interface, which in some arrangements includes icons and/or forms for facilitating entry of the information by a user. In some configurations, information regarding the resources 20 can be entered in the directory 120 automatically as the resources 20 are placed in communication with the control point 110 Similarly, in some arrangements, changes to the resources 20 can be automatically registered in the directory 120.

For example, the control point 110 can include a universal plug and play (UPnP) database comprising specifications or other information regarding resources 20 capable of connection with the control point 110. In some embodiments, the control point 110 automatically populates the directory 120 with the specification of and/or with other information regarding a resource 20 as the resource 20 is connected with the control point 110.

The UPnP database can be updated with changes to the resources 20, such as changes to the specifications or other information regarding the resources 20. For example, in some arrangements, a manufacturer of or service provider for a particular resource 20 can communicate with the control point 110 to update UPnP database, such as with a firmware upgrade for a device or sensor or a change in the input/output parameters of an online application.

In some embodiments, specifications of the resources 20 are stored in the directory 120 in a scripting language (e.g., in one or more scripts). The scripting language can be capable of describing various information regarding the resources 20, such as communication parameters, call/return parameters, real-time and/or space constraints, and/or descriptions regarding complex dynamic behavior of the resources 20, as discussed above, and in further embodiments, can specify the goals and constraints of the system 100, as discussed below. The scripting language can express temporal evolution, spatial relationships, communication parameters, departure from and joining of domains protected by firewalls, and/or network topologies. The scripting language can provide sufficient expressiveness to describe models of complex physical devices (e.g., physical sensors) and services (e.g., online applications) in a heterogeneous network.

The control point 110 can include a compiler for converting information into the scripting language for delivery to the directory 120. For example, the control point 110 can include a UPnP database and, upon detection of a resource 20 for which the specification is contained in the database, can deliver the specification to the compiler for conversion to the scripting language. The control point 110 can then pass the scripting language version of the specification to the directory 120, which can store the specification. Similarly, updates made to the UPnP database can be compiled into scripting language and delivered to the directory 120 such that the update is included in the directory 120. Such updating can be automatic.

In some instances, a user may be versed in the scripting language, and can enter information in the scripting language into the directory 120 without using the compiler of the control point 110. In other instances, the user can use the graphical user interface to enter information in a format more familiar to the user, which information is then converted to the scripting language.

As discussed below, in some embodiments, the scripting language delivered to the directory 120 forms one or more statements. A set of such statements can constitute a scripting language record 122, which may include one or more fields capable of being updated. For example, the UPnP specification of a resource 20 stored in the directory 120 can comprise a scripting language record 122 of that resource 20, and in some instances, the records 122 can be updated via the control point 110 in a manner such as discussed above.

In some embodiments, the directory 120 stores records 122 that detail which resources 20 are interchangeable or provide similar or substantially equivalent functionalities. For example, the records 122 can include information indicating that two or more resources 20 are logically equivalent. This information can be used for fault tolerance purposes. For example, if one service 20 becomes inaccessible (e.g., fails or is disconnected from the system 100), another service 20 may be used instead.

In some embodiments, the directory 120 contains one or more records 122 containing information regarding the topology of the system 100. The record 122 can be updated whenever the network topology changes. For example, if a node of a network were to fail or be compromised, the topology record 122 would be updated to reflect this change.

In some embodiments, the directory 120 stores records 122 for connecting the system 100 with additional resources 20. For example, the records 122 can contain instructions for the control point 110 to connect with a supplemental resource 20 if one or more of the resources 20 fail. By way of illustration, the failed resources 20 can comprise, for example, online applications that provide information on a given topic without charge, and the supplemental resource 20 can comprise an online application that provides the same information, but which charges for the connection time during which the information is accessed. In such a scenario, the system 100 may have as a goal to operate as inexpensively as possible such that the supplemental resource 20 is made available (e.g., a connection therewith is established) only when the free sources of information are unavailable.

The directory 120 can include an interface 124 through which it can communicate with one or more other components of the shell 40. For example, the directory 120 can communicate updates made to the records 122 and/or can receive instructions and/or updates via the interface 124, as further discussed below. As another example, the shell 40 can query the directory 120 through the interface 124. In some embodiments, the directory 120 can be replicated or backed up, such as for purposes of fault tolerance. Any suitable technique may be used for replication or backup, including those known in the art and those yet to be devised.

The shell 40 can include a model generator 130 configured to communicate with the directory 120. The model generator 130 can access or communicate with one or more records 132, 134, which can be in the scripting language. The records 132, 134 can be stored in any suitable manner. For example, the records 132, 134 can be stored in one or more network nodes. In many arrangements, one or more of the records 132, 134 are user-defined, and thus can be created in accordance with the goals the user may desire for the system 100 to achieve and/or limitations the user may desire for the system 100 to avoid. The records 132, 1 34 can be entered via the control point 110.

The records 132, 134 can comprise constraints on the system 100 and can describe one or more objectives of the system 100. In various embodiments, the records 132, 134 comprise one or more of the following: context-awareness policies, such as actions to be taken in the event that a resource 20 obtains a specific reading; failure-handling policies, such as actions to be taken in the event that a resource 20 fails or is disconnected; safety or security policies or parameters, such as a description of which resources 20 may be accessed for use with a particular output 30; distribution policies, such as the manner in which the shell 40 can deploy a computer-executable to a host (described below); timeliness constraints, such as the total amount of time the system 100 is allowed to complete a task; goals; and/or general constraints or requirements of the system 100.

In some embodiments, the records 132 are only used by the model generator 130, and the records 134 are used by both the model generator 130 and a system monitor 200 (which is described below). For example, in certain embodiments, the records 132 comprise failure-handling policies and context-awareness policies, while the records 134 comprise timeliness constraints and general application requirements. In other embodiments, the system 100 does not include records 132. For example, the system 100 can include only records 134.

In further embodiments, one or more records 136 are accessible only by the monitor 200. The records 136 can be written in the scripting language and can be entered via the control point 110. In some embodiments, the records 136 comprise user-defined security policies of the system 100.

The model generator 130 can be configured to generate a proof based on information corresponding to the resources 20 (e.g., information contained in the records 122) and based on the constraints of the system 100 (e.g., based on the records 132 and/or 134). For example, the model generator 130 can generate a model or constructive proof to determine whether the resources 20 are capable of satisfying the objective of the system 100. The constructive proof can contain instructions for using one or more of the resources 20 within one or more of the system constraints (e.g., in a manner consistent with the records 132 and/or 134).

In some embodiments, the model generator 130 comprises a deduction engine that can interpret the scripting language as theories, and can syntactically deduce the logical consequences of a set of scripts. For example, the scripts in the directory 120 and those in the records 132,134 can be interpreted as logical expressions or logical axioms. The deduction engine can synthesize a model from the deductions. Synthesis of the models can proceed in any suitable manner. For example, in some embodiments, a so-called Curry-Howard-style correspondence may be used in the synthesis by the model generator 130 to synthesize a model from a constructive proof.

As briefly mentioned, the scripts contained in the directory 120 can be viewed as a set of logical formulas or a set of axioms of a logical theory of available resources 20. Logical inferences based on such a theory can form a template for all available functionalities that can result from combining the capabilities of each available resource 20.

In some embodiments, to develop a model, the model generator 130 employs a forward-chaining natural deduction based on the axioms in the records 120, 132, and/or 134. For example, the model generator 130 can query the directory 120 for available services and/or devices among the resources 20. From scripts returned as a result of the query, the model generator 130 can deduce whether the response thus received satisfies the system objective. If not, the model generator 130 can use the response to consult the directory 120 again for another resource 20 that will satisfy the system objective. As an end result of such a forward-chaining deduction process, the model generator 130 eventually develops a constructive proof by which the system objective can be satisfied, such as, for example, by triggering the output 30. The constructive proof can indicate that one or more of the resources 20 are sufficient to satisfy the system objective, and can include instructions for using the one or more resources 20 within one or more system constraints to satisfy the system objective. In other embodiments, the model generator 130 employs a backward-chaining deduction, which starts with the system objective, followed by one or more queries to the directory 120.

In some embodiments, the deduction is obtained from a finitely branching, finite deduction tree. The deduction tree can be built on an on-demand basis, thereby conserving space used in the deduction. Throughout the deduction, policies that are respected by the individual resources 20 and the constraints of the system 100 can be used as constraints in the deduction steps. In such embodiments, the deduction process can be relatively inexpensive, in terms of computational resources.

The model generator 130 can also use information regarding the topology of the system 100, as obtained from the directory 120, to impose deployment constraints (e.g., constraints for deploying a computer-executable agent or computer-executable instructions, as described below) in the constructive proof. In some arrangements, in the event that a given record is inconsistent, whether intrinsically or with respect to the available resources 20, the model generator 130 will terminate, and will report the inconsistency. In the event that the available resources 20 are inadequate to implement the objective of the system 100, the model generator 130 can terminate and report the reason for the termination. Reporting of an inconsistency or termination can comprise updating one or more of the records 122, 132, and 134.

The model generator 130 can automatically synthesize constructive proofs or models from the scripting language. Accordingly, the scripting language can be realizable, such that a model that satisfies the specification of a resource 20 can be constructed automatically from the scripting language version of the resource 20.

The models generated by the model generator 130 can be expressed as a modeling language. In some embodiments, the modeling language includes formal operational semantics and incorporates, communicating processes with external and internal actions, hierarchical group structure, group communication and logical and physical migration by processes. External actions can involve, for example, communication, logging into and out of groups, etc. Internal actions can involve, for example, invoking APIs provided by the resources 20. Additionally, the modeling language can communicate time constraints, space constraints, and/or failures, and can include constructs for flow controls. In some arrangements, the modeling language can be dynamically reconfigured, as further discussed below. Such dynamic reconfiguration can involve any suitable replacement method, such as, for example, those used in object oriented paradigms. The modeling language can provide for certification of the provenance of data exchanged via the shell.

In some embodiments, models generated by the model generator 130 can include various advantages. For example, because some models correspond to a proof of the goals or objectives of the system 100 that is deduced both from information particular to the resources 20 and from constraints of the system 100, the model can include intrinsic certification that the system objectives are met, that the system constraints are respected, and that none of the policies of the resources 20 are violated. In some embodiments, the model generator 130 is an example of means for generating a constructive proof that a subset of the resources 20 that are available to the system 100 is sufficient to satisfy the objective of the system 100.

In some embodiments, a model generated by the model generator 130 is passed to an analyzer 140. The analyzer 140 can also accept as input one or more records 142 of non-functional safety properties of the system 100. The safety properties can include, for example, deadlock freedom, data consistency, mutual exclusion, etc. The records 142 can be user-defined, and can be entered via the control point 110. In some embodiments, the records 142 are stored in the scripting language.

The analyzer 140 can determine whether the model received from the model generator 130 is in compliance with the safety properties of the system 100, as set forth in the records 142. For example, in some embodiments, the analyzer 140 includes a static analyzer (e.g., a type checker), which verifies that the model is expressed in the modeling language. A static analyzer can be a combination of a model checker, a type checker, or can implement other suitable program analysis techniques to check conformance of the generated model with safety properties, such as mutual exclusion, absence of race conditions, data consistency, etc. The model/type checker takes as input the model and the one or more records 142 (e.g., the scripting language version of the specifications of the safety properties), and from these, automatically determines whether the model satisfies the specifications. The type checker automatically evaluates safety properties, such as data consistency. In some embodiments, the analyzer 140 is an example of means for determining that a set of instructions violate a user-defined policy.

In certain embodiments, in the event that the analyzer 140 determines that the model does not satisfy the safety properties, the analyzer 140 sends a request to the model generator 130 for the model generator 130 to generate a new model in compliance with the one or more records 142. For example, the analyzer 140 can generate a counterexample in the scripting language. The counterexample is delivered to the model generator 130, which can produce a refined model based on the counterexample. Accordingly, the analyzer 140 can ensure that a model created by the model generator 130 satisfies the safety specifications of the system 100.

In some embodiments, the model is passed from the analyzer 140 to a compiler 150. The compiler 150 can convert the modeling language to a bytecode format in some embodiments. The compiler 150 thus can create a bytecode version of the model produced by the model generator 130 in such embodiments. In some embodiments, the compiler 150 compiles the model into Java bytecode.

The compiler 150 can deliver the converted model to a deployer 160, such as a distribution module. In some embodiments, the converted model includes deployment information that determines the manner in which the deployer 160 distributes the model. For example, in certain embodiments, one or more records 132, 134 that the model generator 130 uses in creating a model can include distribution policies for a computer-executable agent or computer-executable set of instructions (e.g., the bytecode version of the model). These distribution policies can be included in the converted model, which is derived from the model generated by the model generator 130. In other embodiments, the deployer 160 directly accesses the one or more records 132, 134 that contain the distribution policies.

The deployer 160 can deliver the converted model to one or more hosts 170 in compliance with the distribution policies. For example, in some embodiments in which the system 100 comprises only two outputs 30, a first host 170 can be in communication with the first output 30 and a second host 170 can be in communication with the second output 30. If the system 100 includes security constraints that prohibit communication between resources 20 used in developing a bytecode model and the first output 30, the deployer 160 will distribute the bytecode model only to the second host 170 (e.g., for communication with the second output 30).

The deployer 160 can deliver a converted model to the one or more hosts 170 in any suitable manner. For example, in some embodiments, the deployer 160 communicates the converted model via wireless connections. In other embodiments, the connections are wired. Accordingly, in some embodiments, the deployer 160 is an example of means for communicating instructions to a host 170.

The one or more hosts 170 can be distributed among a network, and in some embodiments, each host 170 corresponds with a node of the network. Each host 170 can be in communication with one or more outputs 30. In some embodiments, an output 30 comprises the host 170. For example, the output 30 can comprise physical actuator with an inbuilt processor capable of operating as a host 170. A host 170 can comprise one or more of a machine 180, a driver 190, and a monitor 200. In some embodiments, the host 170 comprises the machine 180 and the driver 190, but the monitor 200 is located elsewhere within the system 100. Other arrangements are also possible.

The machine 180 can comprise an abstract machine or other suitable module for automatically receiving and running the bytecode model. For example, in some embodiments, the machine 180 comprises a Java virtual machine configured to run a Java bytecode model. Abstract machines in different hosts can be connected to each other through a network environment. For some embodiments, the network environment can be a group communication system or an environment such as PVM. The machine 180 can have formal semantics based on the semantics of the modeling language. Prior to operation, the machines can be formally verified for properties such as no message loss, no message reorder, etc. For example, a no message loss property can ensure that messages are not lost during transmission. Retransmission techniques combined with acknowledgements can accomplish this property, in some embodiments. A property of no message reorder can ensure that messages are received by a receiver in the same order in which the sender sent them. This property can be achieved, for example, through the use of timestamps. The machine 180 can include APIs through which processes running on the machine 180 can call services. In some embodiments, a plurality of machines 180 can communicate with each other over a network.

In some embodiments, the machine 180 interacts with an output 30 via the driver 190. For example, in running the converted model, the machine 180 can generate instructions, signals, or other output that is sent to the driver 190, which delivers the instructions, signals, or other output in a format suitable for the output 30 In some embodiments, the output 30 can comprise a physical actuator that is activated when a particular set of instructions is received via the driver 190. In other embodiments, the output 30 can comprise an online application that uses information received via the driver 190.

In certain embodiments, the host 170 runs a monitor 200 in parallel with the machine 180. The monitor 200 can receive input from the machine 180 and is configured to diagnose malfunctions in the operation of the machine 180. The monitor 200 can be in communication with the directory 120 and/or the model generator 130, and can issue one or more recovery actions if such malfunctions occur. For example, if a malfunction is detected (e.g., a process fails to verify the proof accompanying data it received), the monitor 200 can abort or roll back a transaction, dynamically quarantine the output 30 and/or the host 170 from the network, and/or dynamically quarantine one or more processes of the machine 180 (such as when the machine 180 has been compromised).

In some embodiments, the monitor 200 communicates with the directory 120 via the interface 124. The monitor 200 can be configured to detect changes made to the directory 120 (e.g., changes made to one or more of the records 122), and in response, to dynamically modify the execution of the computer-executable model by the machine 180.

For example, changes to the configuration of a resource 20 that are registered in the directory 120 can be reported to the monitor 200. In the event of such a change, which may prevent the host 170 from executing the converted model in such a manner as to satisfy a system objective, the monitor 200 can query the directory 120 for a resource 20 that is logically equivalent to the previous configuration of the changed resource 20. If such a replacement resource 20 exists, the monitor 200 can dynamically reconfigure the processes running in the machine 180 to utilize the replacement resource. The dynamic reconfiguration can employ runtime method updates. In some embodiments, the monitor 200 sends a request to the model generator 130 to utilize the replacement resource 20 in place of the changed resource 20 and to generate and redeploy a new computer-executable model. Accordingly, in some embodiments, the monitor 200 is an example of means for detecting a change in a subset of resources 20 available to the system 100 that prevents the host 170 from executing computer-executable instructions to satisfy the objective of the system 100.

In some embodiments, the monitor 200 is configured to diagnose that a resource 20 and/or a network node has been compromised (e.g., violates the specification or policies of the resource 20 or the system 100). The diagnosis can be based on the behavior of one or more processes in the machine 180. In some embodiments, the diagnosis is abductive. For example, the behavior of the resource 20 can be compared with the model generated by the model generator 130 or with the record 122 that corresponds to the resource 20. The monitor 200 can update the record 122 of a resource 20 to indicate that the resource 20 has been compromised. Additionally, the monitor 200 can send a request to the model generator 130 to utilize a replacement resource 20 in place of the compromised resource.

The monitor 200 can update a topology record 122 to indicate that a network node has been compromised. In certain embodiments, as a result of an update to the topology record 122 made during runtime of the system 100, the directory 120 provides an updated topology record 122 to the monitor 200. In response, the monitor 200 can dynamically redeploy one or more processes under the new topology and can update the dynamic links for proper communication between the processes. Thus, in some arrangements, the monitor 200 can ensure that constraints (e.g., formal guarantees) provided in the models generated by the model generator 130 continue to hold at runtime, even under changing network environments.

As mentioned above, in some embodiments, executable bytecode models are generated in such a way that communication of messages between executable bytecode models either running on the same host or on different hosts is accompanied by (e.g., carries with it) a proof of generation of the message. The proof describes how the message was generated. A bytecode model sends a message to another bytecode model, packaging the message with the proof of its generation. Before accepting a message, a receiving bytecode model checks the proof that accompanies the message. The proof checking is done by comparing the proof with the “model” of the sending entity. In some embodiments, the activities generating the message as recorded in the proof correspond to the capabilities as recorded in the model of the sending entity. The failure of a proof raises a flag. This mechanism is used to certify the provenance or pedigree of the data and helps in preventing generation of spurious triggers for activating resources 20. In further embodiments, the system 100 can subsume models of multilevel security, such as, for example, so-called Bell-La Padula models.

FIG. 3B illustrates another embodiment of the system 100. As described above, in some embodiments, the system 100 comprises one or more resources 20 in communication with the shell 40. The control shell 40 can comprise a deployer 160 that is configured to distribute converted models to one or more hosts 170. In further embodiments, each of the one or more hosts 170 can be in communication with one or more outputs 30. Other arrangements of the system 100 are also possible.

Non-limiting examples of some systems that can employ methods and architectures such as described above are now provided. These examples are provided by way of illustration, and are in no way meant to limit the disclosure herein.

### EXAMPLE 1

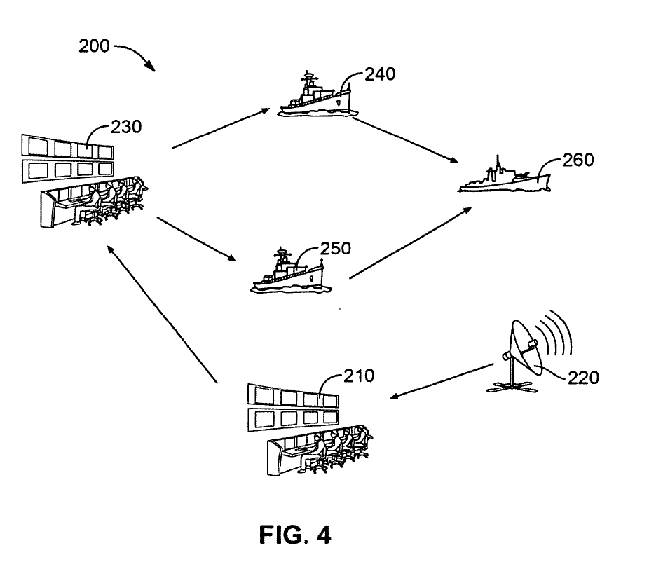

FIG. 4 represents an embodiment of a system 200, such as the systems 10, 100. In the following, some resources are designated as services. In the present example, it is assumed that every resource has a unique address in a network. The system 200 comprises a coast guard patrol fleet guarding a coastline. The system 200 includes a surveying station 210 (also referred to as “SS”) which has at its disposal a radar service that can be invoked using an API, which is exported by a central radar agency 220 (“CRA”), for detecting intruder vessels within the surveyed territory. The system 200 further includes a command station 230 (“Command”), a first destroyer 240 (“Destroyer1”), and a second destroyer 250 (“Destroyer2”). If the surveying station 210 detects an intruder vessel 260, it sends a report to the command station 230 informing of the intrusion as well as the location of the intruder 260. On receiving an intrusion report, the command station 230 sends information regarding the location of the intruding vessel 260 to the first destroyer 240 and also orders 240 with the task of destruction of the intruding vessel 260.

Each of the first and second destroyers 240, 250 has access to an API provided by a missile resource that can be invoked to fire upon intruder vessels. The missile service is exported by a central ordnance service (“COS”) (not shown). On receiving the order to destroy the intruder vessel 260 from the command station 230, the first destroyer 240 invokes the API provided by the missile service using the location information for the intruder vessel 260. The outcome of the firing (success/fail) is reported to the command station 230. If the first destroyer 240 fails to hit the intruder vessel 260, the command station 230 tasks the second destroyer 250 to destroy the intruder vessel.

In certain embodiments, the modeling language can be built on top of classical process calculus and provides a formal programming model for resource coordination. The syntax of one embodiment is provided below as recursive EBNFs. In this embodiment, the modeling language has operational semantics involving interactions between observable actions, communication, and silent computations. Additionally, the language can model timeouts and failures (e.g., in monadic style).

| | |
|---|---|
| (Model) | |
| M::= | |
| Ifp B (I) | (recursive model with an identifier) |
| {N} M | (physical/logical host with name) |
| M\hat{ }M | (two models spatially coexisting in a distributed |
| | network) |
| N ::= | |
| x | (XML namespace) |
| n | (name from an XML namespace) |
| (Bytecode Model) | |
| B::= | |

| | |
|---|---|
| (local n) B | (restriction) |

| | |
|---|---|
| dead | (dead bytecode model) |

```
          B₁ comp B₂ (par. composition of bottom-level bytecode
          models)
```

| | |
|---|---|
| Id | (bytecode model identifier) |
| Ext;B | (Observable action) |
| Sil;B | (Silent behavior) |

| | |
|---|---|
| failure(Id) | (failure module) |
| handle(Id);B | (failure handle notation) |
| timeout t;B | (timeout) |

| | |
|---|---|
| [a₁(x₁),...;...aₙ(xₙ)] | (API export) |
| Ext ::= | (observable actions) |
| Sec | (Security) |
| C | (Comm.) |
| C::= | (Comm.) |
| Ch(x) | (input) |
| Ch<Str> | (output of string Str) |
| mcg(C₁,...,Cₙ)<Str> | (group multicast of string Str) |
| Ch::= N | (Channel) |
| Sec ::= | |
| login N | (login to a logical/physical host) |
| logout N | (exit a boundary) |

| | |
|---|---|
| Sil::= | (silent behavior) |
| let x=S in Sil | (let reduction) |
| if θ then B else B′ | (control flow) |

| | |
|---|---|
| modify(Id://aᵢ) | (reconfiguration by substituting resource) |

| | |
|---|---|
| θ | (constraint) |

| | |
|---|---|
| fail(Id) | (failed computation) |
| S::= | |

| | |
|---|---|
| Id://aᵢ(y) | (API exported by resource) |

```
Id://aᵢ(y)::=
    preᵢ~postᵢ[y] (pre and post conditions for invoking an API)
θ::=
    x >=y+c
    x>y+c
    x =< y+c
    x<y+c
```

In this embodiment, a model can consist of several submodels, mutually recursive executable bytecode models (e.g., lfp is the least fixpoint), or a named logical or physical host that contains a running model inside. A recursive model can perform observable actions, exhibit silent behavior, detect and handle failures, and act as a resource exporting APIs that can be invoked by itself or other bytecode models. Observable action involves communication, logging in and out of physical and logical hosts. Silent computation takes place by calling APIs exported by resources. It can also involve failure handling and dynamic reconfiguration through substitution of one resource for another. APIs exported by resources are described by their interfaces, which include pre- and post-conditions that hold before and after invoking an API. The pre- and post-conditions can be simple type judgments (the types of the parameter passed) and arithmetic constraints. As an example, the workflow for the first destroyer 240 can be expressed as:

Ifp Destroyer1=
destroyer1(“destroy”, x);
let y= COS://missile(x) in
Command<y>;Destroyer1

In certain embodiments, the scripting language is based on an intuitionistic mathematical logic. The language can describe both temporal and spatial evolution and has atomic constructs for describing relations among variables. The basic syntax of one embodiment is provided below as EBNFs.

| | |
|---|---|
| P ::= | |
| defun prop | (property definition) |
| OR(P1,P2) | (disjunction) |
| &&(P1,P2) | (conjunction in infix notation) |
| →(P1,P2) | (intuitionistic implication) |
| ~ P | (intuitionistic negation) |
| Finally P | (temporal evolution) |
| \| | (variable for participant identifier) |
| Knows(u\| Q) | (epistemic operator signifying knowledge of |
| | object) |
| Invoke(u\|v\|Q1\|Q2\|) | (invocation of API) |
| Send(u,Q) | (message send) |
| T | (constant true) |
| Exists(I,P) | (quantification over participant identifiers) |
| prop::= | |
| ID Varlist | |
| ~ Var Constant | |
| ~::=> \| <\| ≦\| ≧ | |

In this embodiment, the scripting language includes participant identifiers standing for states and constructs for expressing communication, resource description, knowledge, etc. Services are defined in terms of their properties using the defun construct (akin to Lisp). A property can be a predicate or a constraint (i.e., an identifier followed by a list of variables). In the above, Q's denote patterns. Patterns are strings and can be regular expressions. They can characterize both bytecode models and resources. For example, “Knows(u I Q)” above denotes that the bytecode model matching the pattern Q knows the object u. A bytecode model can know an object only if it has received a communication of it. “Invoke(u|v|Q1|Q2|I)” describes the properties of a resource declaratively. This phrase describes an API exported by a resource to which an object u is passed as parameter, returns object v, satisfies the pattern Q1, can be invoked by a bytecode model that matches the pattern Q2, and is exported by the entity identified by I (that includes the location of the entity).

As an example, consider the first destroyer 240 described above. If the first destroyer 240 bytecode model receives an intrusion report x along with a “destroy” command (i.e., comes to know of an intrusion report along with a “destroy” command) the destroyer 240 will use that report to fire a missile in an attempt to destroy the intruder vessel 260 by invoking some API exported by some resource. This can be specified in the scripting language as follows:

Knows(x, “destroy”| Destroyer1) →Finally(Invoke(x| missile_response|
*.input:IntrusionReport.*| Destroyer1 | W));

Here, W is a placeholder since the name of the service is not yet known, nor is the entity exporting the service known. Once these items are discovered, the proper pattern, as well as the proper nominal, will be instantiated by a model generator 130 (not shown) of the present, illustrative example. The phrase “*.input:IntrusionReport.*” is a regular pattern indicating that the service accepts the type “IntrusionReport” as input where * describes wildcard. A substantial variety of security policies and context-awareness requirements can be specified in the scripting language. The foregoing example of one embodiment of the scripting language is provided by way of illustration, and should in no way be interpreted as limiting the disclosure as claimed.

The system 200 can have coordination requirements (e.g., system constraints) such as the following, which may be stored in one or more records such as the records 122 described above:

```
Finally(Invoke( |“intrudervessel”, location| *input: null, output:
    IntrusionReport*|SS| U) && C0 && C1 && C2 && ...)
C0: Invoke( |“intrudervessel”, location| *input: null* |SS| U)→
    Finally(Send(“intrudervessel”, location,SS))
C1: Send(x, SS) → Finally(Knows(x| COMMAND))
C2: Knows(“intrudervessel”, location;COMMAND)
    →Finally(Send(“destroy”, location, COMMAND) )
C3: Send(“destroy”, location, COMMAND) → Finally(Knows(“destroy”,
    location| Destroyer1))
C4: Knows(“destroy”, location; Destroyer1)) → Finally(Invoke(location|
    missile_response | * input: intpair, output: Boolean *| Destroyer1 |
    W))
...
```

These coordination requirements are referred to hereafter as “Cspec”. In the foregoing, “IntrusionReport” represents a concatenation of the strings “intrudervessel” and the location of the intruder vessel 260. Additionally, “missile_response” is a Boolean with values “success” and “failure”. The specification Cspec states that the surveying station 210, or the SS “entity”, will finally be able to obtain information about an intrusion by invoking some API exported by some resource and, if it obtains this information, will finally send it out as a message (e.g., C0). If the SS bytecode model sends a message, it should be finally received by the command station (C1). If the command station 230 comes to know of (i.e., receives) an intrusion report, then the command station 230 will finally send out a command ordering destruction of the intruding vessel (C2). If the command station 230 sends out a destroy command, this command will finally be heard by the first destroyer 240 (C3). If the first destroyer 240 receives a command to destroy an intruding vessel, then it will finally invoke some API exported by some resource to fire at the intruder vessel and destroy it (C4), and so on.

In this embodiment, the temporal “Finally” modality in the scripting language stands for branching time evolution. Additionally, the specifications are written in a possibilistic or “permissive” mode. For example, in C1, because of the branching time semantics of “Finally”, it is only a possibility that the message will finally be received (i.e., there will exist a run in which this occurs). It is also possible that in some run the message will be lost in transit. The specification can be fashioned to deal with such situations. Workflows will be synthesized from such possibilistic specifications, thus enabling the synthesis of fault tolerant workflows. From the scripting language, the model generator 130 can synthesize the SS bytecode model as a model (as described hereafter).

Consider the radar service exported by the central radar agency 220. The service is specified by the following script:

Radar(, CRA, W) → Invoke( |“intrudervessel”, location| *input: null,
output: IntrusionReport * |W| CRA)

This script is referred to hereafter as S1. Here the service is exported by the resource CRA, and provides an API Radar whose invocation does not require any formal parameter to be passed and returns the type IntrusionReport that consists of a pair that consists of the string “intrudervessel” and a value of type location. From Cspec, when the model generator 130 of the present, illustrative example encounters

Invoke(|“intrudervessel”, location|*input: null, output: IntrusionReport*|SS|U),

the model generator 130 starts a subtree for natural deduction. The model generator 130 assumes in natural deduction style, Radar(,CRA, SS). Using S1 and the implication elimination rule, the model generator 130 deduces

Invoke(|“intrudervessel”, location|*input: null, output: IntrusionReport * |SS|CRA).

Using standard the implication-introduction rule in natural deduction, the model generator 130 deduces

Radar(, CRA, SS) → Invoke( |“intrudervessel”, location| *input: null,
output: IntrusionReport * |SS| CRA)

Based on this deduction the model generator 130 constructs the model for the surveying station 210 as

lfp SS=let y=CRA://Radar( ) in . . .

As shown, discovery of the “CRA://Radar( )” service is automated by the model generator 130 by using deduction. If multiple resources needed to be combined the natural deduction procedure would have correctly discovered the combination.

The basic deduction is conducted as a forward-chaining procedure, and whenever a goal involving an “Invoke” construct is encountered a companion proof tree is developed to discover the proper service. This companion deduction can be viewed as computing a logical interpolant. After the implication introduction, the assumption is discharged. The deduction, as well as the synthesis of bytecode models, can be carried out entirely automatically and can be implemented in software. From C0, the model generator 130 deduces “Send(“intrudervessel”, location, SS)”. From this and C1, the model generator 130 deduces “Knows(x|COMMAND)”. From these two deductions, the model generator 130 refines the model for SS as “lfp SS=let y=CRA://Radar( ) in Command<y>; . . . ”. In addition the model generator 130 constructs the COMMAND bytecode model as “lfp COMMAND=Command(y); . . . ” Here, “Command” is a new channel. In this manner the model generator 130 continues the deduction and simultaneously synthesizes bytecode models until no additional new facts are produced.

The formal operational semantics of a machine 180 (not shown) of the present, illustrative example can be implemented in software. An example of the semantics are declaratively provided below. In the following it is assumed that ┌ is an environment and that ┌/I denotes the restriction of ┌ to the bytecode model identified by the identifier I. In some embodiments, the environment can be implemented through a group communication system or a messaging platform like PVM.

[symbol]

/I′ [symbol] I://aᵢ=pre~post[xᵢ] (Serv inv. 1) [symbol]
/I′ [symbol] I://aᵢ(y) → pre~post[y/xᵢ] [symbol]
/I′, N [symbol] pre[y/xᵢ]→true (Serv inv. 2) [symbol]
/I′ [symbol] pre~post[y/xᵢ]→post[y/xᵢ] [symbol]
/I′ [symbol] Complete(x) [symbol] /I′ [symbol] val x = t [symbol] /I′ [symbol] post::= (σ[x] \hat{ }
ρ[x]) x [symbol] ( [symbol] /I′□N [symbol] (σ[x] \hat{ } ρ[x])[t/x]) (Serv.inv fail) [symbol]
∪{fail(I)} [symbol] post →false

The first rule (Serv. inv. 1) states that before a service invocation, the preconditions of the service are evaluated. The second rule (Serv inv. 2) states that service invocation proceeds if the pre-condition evaluates to true (true and false are constants). The third rule (Serv. inv. fail) describes the manner in which the failure of a service is registered by the environment. If the “Complete” predicate of the environment (which registers when a service invocation is completed) is true, the resulting value does not satisfy the post condition. As a result, it is registered that the resource exporting the API aᵢ has failed. This information will be used for failure handling by other bytecode models. For example, as illustrated by the rule below, the bytecode model failure(Id) is executed whenever any other bytecode model I′ makes reference to handier(I):

[symbol]

[symbol]

fail(Id) (failure composition) [symbol]
/I′ [symbol] handle(Id);P → failure(Id)

### EXAMPLE 2

Wireless sensor networks can be advantageously employed in a wide variety of applications. Some wireless devices (which can also be referred to as “motes”) that are capable of collecting data from a sensor and relaying that data wirelessly throughout a network via any suitable method can allow for autonomous collection and processing of environmental conditions over a given area. Certain of such motes can communicate via radio frequency (“RF”) transmissions, and may communicate with other motes in the network.

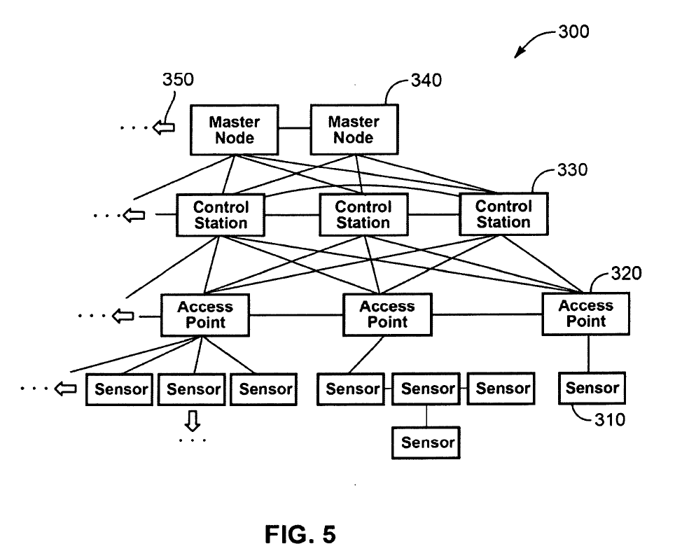

FIG. 5 represents an embodiment of a system 300, such as the systems 10, 100, 200, which can comprise a wireless sensor network. The system 300 can be configured for use in intelligent monitoring and control of soil properties and irrigation. For example, in some arrangements, a watering system for a landscaped property comprises the system 300. Embodiments of the system 300 can be adapted for use in other environments as well, as further described below.

In certain embodiments, the system 300 includes one or more sensors 310 that are physically distributed throughout the landscaped property. The sensors 310 can be buried underground or otherwise situated as desired. In some embodiments, the sensors 310 are in communication with one or more access points 320, each of which can comprise one or more motes. Accordingly, the access points 320 may also be referred to hereafter as motes. In some embodiments, the access points 320 are in communication with one or more control stations 330, each of which, in turn, can be in communication with one or more master nodes 340 of a distributed network.

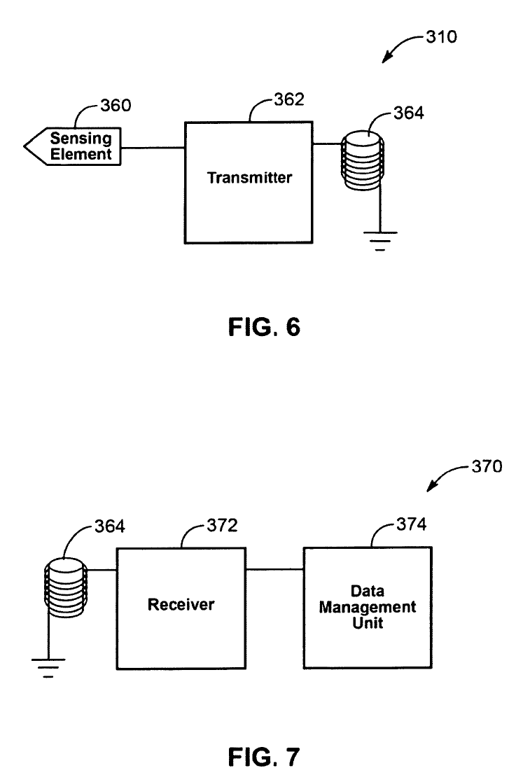

With reference to FIG. 6, in certain embodiments, one or more of the sensors 310 are configured to transmit data using magnetic induction (“MI”) transmissions. MI transmission can be particularly advantageous in underground environments or other environments which can significantly attenuate and/or substantially block RF transmissions. For example, in comparison to RF transmission, MI transmission can be relatively unaffected by the medium through which it propagates (e.g., air, water, soil, rock, etc.).

In some embodiments, a sensor 310 comprises one or more sensing elements 360, such as, for example, a soil moisture probe. The sensing element 360 can be in communication with a transmitter 362. The transmitter 362 can receive information regarding a physical property of the soil, such as the moisture content of the soil, from the sensing element 360, and can transmit this information by MI transmission via a ferromagnetic coil 364. For example, the transmitter 362 can cause a signal of current to flow within the coil 364 in a manner that represents the information to be transmitted, which can generate a time-varying magnetic field.

With reference to FIG. 7, in some embodiments, one of more of the sensors 310 comprises a receiving unit 370. For example, in some arrangements, one or more sensors 310 are configured to both send and receive IM signals, and can communicate with each other.

The receiving unit 370 can comprise a coil 364. When a signal in the form of a time-varying magnetic field is incident on the coil, a corresponding voltage can be induced. The receiving unit 370 can further comprise a receiver 372 for detecting the signal. For example, the receiving unit 370 can detect varied flow of current through the coil that may result from the induced voltage.

In some embodiments the receiving unit 370 includes a data management unit 374 in communication with the receiver 372. The data management unit 374 can be configured to store, convert, manipulate, or otherwise use information received from the receiver 372. For example, the data management unit 374 can include an LCD panel for displaying information regarding the transmitted information, an RF transmitter for relaying the information, a data logger for storing the information and/or some other suitable device. In some embodiments, the data management unit 374 can be in communication with the transmitter 362 (see FIG. 6) of a sensor 310, and can instruct the transmitter to send information to an access point 320, as further described below.

With reference again to FIG. 5, in certain embodiments, one or more sensors 310 each may communicate directly with an access point 320 via MI transmission, as illustrated by the leftmost grouping of sensors 310 and the leftmost access point 320. In other embodiments, one or more sensors 310 may be distanced sufficiently far from the access point 320 to substantially prevent effective direct communication between some of the sensors 310 due to a relatively small transmission range of the transmitters 362. In certain of such embodiments, a first sensor 310 may transmit data to a nearby second sensor 310, which in turn may transmit the received data (along with additional data that it has gathered, in some instances) to yet a third sensor 310 which is out of the range of the first sensor 310. The third sensor 310 may then transmit data received from the other sensors 310 and/or data it has gathered to an access point 320. An example of such a relay of sensors 310 is illustrated in the middle grouping of sensors 310 in FIG. 5, which are shown as communicating with the middle access point 320 via a single sensor 310. In various embodiments, the system 300 can include hundreds, thousands, or even millions of sensors 310.

In some embodiments, the sensors 310 form a wireless network that employs only MI transmission. However, in other embodiments, the wireless network can use other suitable communication mechanisms instead of or in addition to MI transmission.

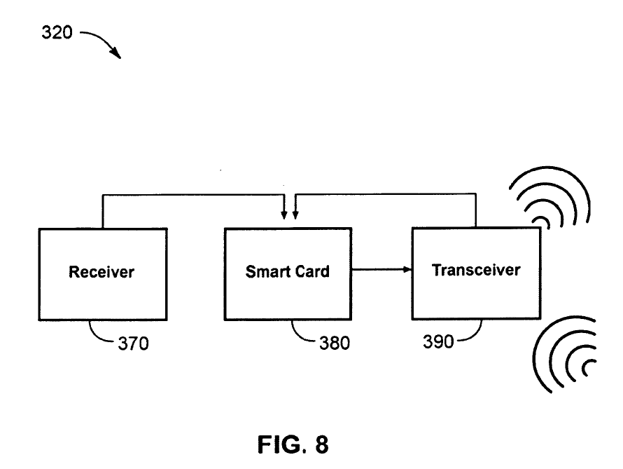

With reference to FIG. 8, in certain embodiments, an access point 320 can comprise a receiver 370 such as described above, and thus can receive signals transmitted by one or more sensors 310. The receiver 370 can further include a smart card 380 or any other suitable computing element in communication with the receiver 370.

The smart card 380 can further be in communication with (e.g., can transmit information to and/or receive information from) a secondary communication device, such as a transceiver 390, that is configured to permit communication between the access point 320 and one or more additional elements of the system 300. For example, in some embodiments, the access point 320 is configured to communicate with one or more other access points 320, one or more control stations 330, and/or one or more master nodes 340 via the transceiver 390 (see FIG. 5). In some embodiments, infrared transceivers, cables, wires, or other suitable communication media are used instead of or in addition to the transceiver 390.

With reference again to FIG. 5, in some embodiments, one or more of the access points 320 are positioned at or above ground level and are capable of communicating with one or more sensors 310 that are positioned underground. For example, each access point 320 may be in communication with a specific subset of sensors 310. The access points 320 can receive information from the sensors 310 and can communicate that information and/or additional information to one or more access points 320, control stations 330, and/or master nodes 340. In some embodiments, one or more access points 320 may be arranged in a relay such that a subset of access points 320 communicates with each other and a single access point 320 of the subset communicates with a control station 330 and/or a master node 340.

The control stations 330 can assimilate and manage information received from the access points 320, which may be used in decision making, data logging, or other desired tasks. The master nodes 340 can receive data from the control stations 330 and can make decisions on or otherwise utilize the data thus received.

Any other suitable arrangement is also possible. For example, in some embodiments, the access points 320 can communicate directly with the master nodes, thereby eliminating the control stations 330. In other embodiments, the network can comprise only sensors 310 and access points 320. For example, the access points 320 can include networking software and can serve as network nodes. In still other embodiments, layers in addition to those shown in FIG. 5 can be used. For example, devices may be inserted to communicate between the access points 320 and the control stations 330. Any suitable combination of the master nodes 340, control stations 330, access points 320, and/or sensors 310 can be positioned above or below ground or water, or may be suspended in air in any suitable manner (e.g., may be positioned on a pole, in an aircraft, etc.).

As illustrated by the arrows 350, the system 30 can include a much larger number of nodes 340, control stations 330, access points 320, and/or sensors 310 than those shown. A hybrid of communication techniques may also be used to connect any element in the network. For example, some sensors 310 may communicate via MI transmission, while others may use cable, RF, infrared, or other technologies. Similarly, the nodes 340, control stations 330, and/or access points 320 can use any suitable combination of such technologies to communicate.

The system 300 can include one or more shells 40 (not shown in FIG. 5) such as described above in any suitable number and/or distribution. For example, in some embodiments, one or more nodes 340 and/or control stations 330 include one or more directories 120, model generators 130, analyzers 140, compilers 150, and/or deployers 160. In some embodiments, each access point 320 comprises a host 170. For example, the smart card 380 of a sensor 320 (see FIG. 8) can serve as a host 170 on which a converted model can be executed. Other elements of the system 300 can also serve as hosts 170, including the nodes 340 and/or the control stations 330.

The sensors 310 can comprise resources 20 that are available to the system 300. In some embodiments, the system 300 utilizes information gathered from the sensors 310 to determine whether to actuate sprinklers via an output device 30 (not shown in FIG. 5), such as, for example, any suitable actuator such as one or more valves comprising solenoids.

In certain embodiments, the smart card 380 (see FIG. 8), which can be running a set of computer-executable instructions issued by a deployer 160, can receive information regarding the operational status of a sensor 310 and/or data regarding the moisture content of the soil from the sensor 310 via the receiver 370. This information and data can be delivered via the transceiver 390 to the appropriate location or locations (e.g., to one or more nodes 340 and/or control stations 330) within the distributed network of the system 300 to update a directory 120, which can comprise a record 122 for the sensor 310. If the information received from the sensor 310 is sufficient to provide a trigger, in some embodiments a node 340 may actuate an output device 30 to turn on the sprinkling system.

In some embodiments, the smart card 380 comprises a Java Smart Card that comprises a Java virtual machine. Java Smart Cards can permit small Java-based applications to run securely on them by incorporating Java kilobyte virtual machines. A smart card can contain an embedded device (i.e., a microcontroller) that provides a user with the ability to program the card and assign specific tasks to occur as a result of given events. The computer-executable instructions thus can be issued in the form of Java bytecode that can run securely on top of the Java virtual machine.

In some embodiments, the smart card 380 is placed in communication with the receiver 370 via a serial I/O. The smart card can comprise a controller that includes electrical contacts that are connected to an output port of the receiver 370. A Java applet or application downloaded to the microcontroller can process incoming signals and can act accordingly by initiating commands to send data regarding the received signal to the transceiver 390. The data can be securely protected through an applet firewall that restricts and checks access of data elements from one applet to another.

By employing a control shell 40 such as described above, the system 300 can include a scalable intelligent software-based coordination infrastructure. Distributed intelligent agents (e.g., instructions distributed by a model generator 130 and converted by a compiler 150) can use data from the sensors 310 and user-defined system management policies to generate real-time control of the system 300. In some embodiments, the control decisions are delivered to appropriate personnel for manual intervention. For example, the decision can be delivered to a control point 110 comprising a graphical user interface via which a user can provide commands to the system 300. In other embodiments, the decisions are made without manual intervention, and are delivered directly to an output device 30. The shell 40 can provide for intelligent monitoring and control of soil properties. As discussed, the shell 40 can include a software tool that provides policy-based, on-demand coordination of the irrigation system 300. Other aspects and advantages of embodiments of the system 300 will also be apparent to those of skill in the art from the disclosure herein.

In certain embodiments, access points 320 comprising Java Smart Cards, which can interpret data through bytecodes, can consume less power than known motes. Such access points 320 can also be relatively smaller and much cheaper than known mote devices, in some instances. For example, the cost of manufacturing some arrangements can be only slightly over 10% the cost of manufacturing known mote devices. Furthermore, unlike certain embodiments disclosed above, known motes are not configured to communicate with IM transmission devices, nor are they configured to communicate with a large number (e.g., thousands or millions) of sensors that are intelligently interconnected via dynamically changeable software, such as that provided by control shells 40.

Embodiments of the system 300 can be employed in a variety of contexts. For example, in some embodiments, the system 300 can comprise an underground network of soil moisture sensors which may be fully buried (e.g., no cables or protrusions extending to the surface). Such a network could be used in agriculture to control irrigation. In some embodiments, the system 300 can comprise an underground network of pressure, vibration, movement, audio, and/or other sensors that could be a valuable defensive and monitoring system for military use. In other embodiments, the system can comprise an underwater network of sensors for monitoring water properties, such as temperature, quality, or quantity, plant or animal life and conditions, or a variety of other underwater applications. In some embodiments, the system 300 can comprise a network of implanted biomedical sensors configured to coordinate the acquisition of certain vital signs or biological conditions of a patient. Such a network configuration can allow one sensor which detects a certain problem, such as a high fever or a heart condition, for example, to request other sensors to acquire relevant data immediately to assist in problem solving decision making. In other embodiments, the system can comprise a network through any medium in which short range communication is desirable. For example, a personal digital assistant, watch, cell phone, laptop, and personal computer can all synchronize to each other if within transmission range.

Various embodiments of the systems 10, 100, 200, and/or 300 include one or more advantageous features, such as the following. Certain embodiments provide for the reliable satisfaction of the goals (e.g., business goals) of a user, ensure that the quality of service constraints of the user are respected, and ensure that none of the policies imposed by individual services and devices of a system, nor those imposed by the system, are violated, even under rapidly changing environments, and some systems ensure that non-functional safety constraints of the system are satisfied. Certain of such embodiments can be particularly suited for deployment in mission-critical applications, such as patient monitoring or building security.

Some embodiments incorporate expressive yet tractable languages to describe models of complex heterogeneous physical devices, such as actuators or sensors. Some embodiments permit automatic synthesis of workflows from declarative specifications of the business logic and quality of service goals of a system and from models of available devices and services. Further embodiments provide models that are created and implemented in a manner that provides security features and that meets the quality of service goals of a system. Certain embodiments provide a mechanism for certifying the provenance of data exchanged between processes and prevent generation of spurious triggers for activating services and/or devices of a networked system.

Some embodiments provide for automatic and controlled deployment and running of bytecode models or computer-executable instructions obtained from constructive proofs. The bytecode models can be generated automatically from user-defined system constraints such that the system functions substantially autonomously and without any or without extensive software development by the user. Some embodiments provide for readily deployable systems that can be easily adapted to meet the system goals of a user. Further embodiments permit reconfiguration of a workflow at runtime, which reconfiguration can include substituting new services and/or devices for existing ones and/or can provide new functionalities in response to changing requirements of or changing resource availabilities to a system, even when such conditions change rapidly.

Some systems can be easily reconfigured, such as when a user wishes for the system to conform to new or different policies. In some embodiments, the user can readily enter these policy changes via a control point 110. Some systems can also be rapidly deployable, such that the system can begin operation soon after policies, goals, and system objectives are created.

Various embodiments may be advantageously employed in numerous contexts, such as those for which intelligent and/or reliable service coordination is important. For example, embodiments may be used for: generating mashup engines for intelligent location tracking and mapping; soil and water management and irrigation control for agricultural and environmental applications; intelligent distributed power control, such as control of a power grid; home entertainment and security; distributed intelligent control of Internet-based appliances; distributed robot control; intelligent control of manufacturing plants and inventory management; reliable and smart emergency management applications; on-line, flexible assembly of operationally responsive spacecrafts; intelligent and reliable control of guided missiles; tracking and monitoring for homeland security; cognitive antennas, including multiple input/multiple output (MIMO) systems that use numerous antennas to optimize communication; cognitive radars; cognitive radios; automatic hospital management and/or monitoring of the delivery of therapeutic drugs; and automated distributed fermentation control, as well as modulation of cellular metabolism. Other applications are also contemplated.

Embodiments of the systems 10, 100, 200, and 300 and/or components thereof, can be implemented in hardware and/or software. Further, it will be obvious to those having skill in the art that many changes may be made to the details of the above-described embodiments without departing from the underlying principles of the invention. For example, any suitable combination of the components of the systems 10, 100, 200, and/or 300 is possible. The scope of the present invention should, therefore, be determined only by the following claims.

1. A system distributed among a plurality of network nodes, each node comprising a storage device, the system configured to automatically generate computer-executable instructions for controlling one or more of the network nodes so as to satisfy a user-defined system objective, the system comprising:
a directory of available system resources, the directory including information corresponding to a plurality of applications;
a model generator configured to generate a constructive proof that a first subset of the system resources is sufficient to satisfy the system objective, the model generator using at least a portion of the information corresponding to the applications to generate the constructive proof, the constructive proof comprising a first set of instructions for using the first subset of system resources within one or more system constraints;
a compiler configured to convert the first set of instructions into the computer-executable instructions, and
a distribution module configured to automatically deploy the computer-executable instructions by communicating the computer-executable instructions to a host device, the host device configured to execute the computer-executable instructions to control a data output device according to the first set of instructions.

2. The system of claim 1, further comprising a monitor in communication with the host device and the directory of available system resources, the monitor configured to:
detect a change in the first subset of system resources that prevents the host device from executing the computer-executable instructions to satisfy the system objective;
determine a second subset of the system resources available in the directory that is logically equivalent to the first subset of system resources; and
dynamically modify the host device's execution of the computer-executable instructions to substitute the second subset of system resources in place of the first subset of system resources.

3. The system of claim 2, wherein the monitor is further configured to send a request to the model generator to generate a second set of instructions based on a third subset of the available system resources.

4. The system of claim 2, wherein the monitor is further configured to:
determine that a security violation has occurred in the host device; and
update a field in the directory corresponding to the host device to indicate that the host device has been compromised.

5. The system of claim 4, wherein the monitor, in response to detecting the change in the first subset of system resources, is further configured to instruct the host device to perform a recovery action.

6. The system of claim 1, wherein the one or more system constraints are related to the system objective and are selected from the group comprising system security policies, context awareness policies, timing policies, failure handling policies, safety policies, and computer-executable instructions distribution policies.

7. The system of claim 1, further comprising an analysis module configured to:
determine that the first set of instructions violate a user-defined policy; and
send a request to the model generator to generate a second set of instructions that satisfy the user-defined policy.

8. The system of claim 1, wherein the information corresponding to the plurality of applications comprises, for each available application, a description of input data available from the application, instructions for accessing the application, instructions for providing output data to the application, and instructions for processing the input data from the application.

9. The system of claim 1, wherein the host device comprises a smart card.

10. A system distributed among a plurality of network nodes, each node comprising a storage device, the system configured to control one or more of the network nodes so as to satisfy a user-defined system objective, the system comprising:
a directory of available system resources, the directory including information corresponding to:
a plurality of network applications; and
one or more input devices;
a model generator configured to communicate with the directory to generate a constructive proof that a subset of the system resources is sufficient to satisfy the system objective, the constructive proof comprising instructions for using the subset of system resources within one or more system constraints; and
a distribution module configured to communicate the instructions to a host device, the host device configured to execute the instructions to control a data output device.

11. The system of claim 10, wherein the information corresponding to the plurality of network applications and the one or more input devices comprises logical scripts.

12. The system of claim 11, wherein the directory is configured to deliver logical scripts to the model generator and the model generator is configured to deduce a constructive proof from the logical scripts.

13. The system of claim 10, wherein the model generator is configured to employ forward-chaining deduction to generate the constructive proof.

14. The system of claim 10, further comprising a compiler configured to receive the constructive proof from the model generator and to convert the instructions to executable code for delivery to the distribution module.

15. The system of claim 10, wherein the information corresponding to the one or more input devices comprises, for each input device, a description of data available from the input device, instructions for querying the input devices and instructions for processing the data available from the input device.

16. A system distributed among a plurality of network nodes, each node comprising a storage device, the system configured to control one or more of the network nodes so as to satisfy a user-defined system objective, the system comprising:
means for storing information regarding available system resources, the system resources comprising a plurality of applications;
means for generating a constructive proof that a subset of the system resources is sufficient to satisfy the system objective, the constructive proof comprising instructions for using the subset of system resources within one or more system constraints, and
means for communicating the instructions to a host device, the host device configured to execute the instructions to control a data output device.

17. The system of claim 16, further comprising means for detecting a change in the subset of system resources that prevents the host device from executing the computer-executable instructions to satisfy the system objective.

18. The system of claim 16, further comprising means for determining that the set of instructions violate a user-defined policy.

19. A method for automatically generating computer-executable instructions for controlling one or more nodes distributed in a network so as to satisfy a user-defined system objective, the method comprising:
storing information corresponding to a plurality of system resources;
generating a constructive proof that a first subset of the system resources is sufficient to satisfy the system objective, the constructive proof comprising a first set of instructions for using the first subset of system resources within one or more system constraints;
compiling the first set of instructions into the computer-executable instructions; and
distributing the computer-executable instructions to a host device through the network.

20. The method of claim 19, further comprising executing the computer-executable instructions on the host device to control a data output device according to the first set of instructions.

21. The method of claim 19, further comprising:
detecting a change in the first subset of system resources that prevents the host device from executing the computer-executable instructions to satisfy the system objective;
determining a second subset of the system resources available in the directory that is logically equivalent to the first subset of system resources; and
dynamically modifying the execution of the computer-executable instructions by the host device such that the second subset of system resources is substituted in place of the first subset of system resources.

22. The method of claim 21, further comprising sending a request to the model generator to generate a second set of instructions based on a third subset of the available system resources.

23. The method of claim 21, further comprising:
determining that a security violation has occurred in the host device; and
updating a field in the directory corresponding to the host device to indicate that the host device has been compromised.

24. The method of claim 23, further comprising instructing the host device to perform a recovery action.

25. The method of claim 19, wherein the one or more system constraints are related to the system objective and are selected from the group comprising system security policies, context awareness policies, timing policies, failure handling policies, safety policies, and policies for distribution of the computer-executable instructions.

26. The method of claim 19, further comprising:
determining that the first set of instructions violate a user-defined policy; and
sending a request to the model generator to generate a second set of instructions that satisfy the user-defined policy.

27. The method of claim 19, wherein the information corresponding to the plurality of system resources comprises, for each available resource, a description of input data available from the resource, instructions for accessing the resource, instructions for providing output data to the resource, and instructions for processing the input data from the resource.
